(19) United States
(12) Patent Application Publication
(10) Pub. No.: US 2020/0328995 A1
(43) Pub. Date: Oct. 15, 2020

(54) SYSTEMS, METHODS, AND STORAGE MEDIA FOR TESTING A COMPUTING PLATFORM BASED ON A REPLAY OF NETWORK TRAFFIC

(71) Applicant: CBS Interactive Inc., San Francisco, CA (US)

(72) Inventors: Jonathan Lee, Louisville, KY (US); Christopher Hamm, Sellersburg, IN (US); Jason Chuong, Walnut Creek, CA (US)

(73) Assignee: CBS Interactive Inc., San Francisco, CA (US)

(21) Appl. No.: 16/379,964

(22) Filed: Apr. 10, 2019

(51) Int. Cl. H04L 12/58; H04L 12/24; H04L 29/06; G06F 16/955

(52) U.S. Cl. CPC H04L 51/063; G06F 16/9566; H04L 63/1425; H04L 41/145

(57) ABSTRACT

Systems, methods, and storage media for testing a computing platform based on a replay of network traffic are disclosed. Exemplary implementations may: access a network activity log storing messages indicating previous network activity on a set of networked computing devices; publish a set of modified messages to a subscription queue for use in a test environment; send the modified objects as simulated network traffic to a replay test environment; and monitor the operation of the test environment based on the simulated network traffic.

### FIELD OF THE DISCLOSURE

The present disclosure relates to systems, methods, and storage media for testing a computing platform network based on a replay of network traffic.

### BACKGROUND

It is known the test computer networks for response to various network traffic loads. For example, AKAMAI™ provides CLOUDTEST™, a platform for network load testing. Open source tools for load testing include SIEGE™ and VEGETA™. Load testing systems log messages, such as request messages in a computing environment and reproduce the logged messages in a test environment. Known systems and methods require that the test be setup well in advance and designed for specific testing objectives and environments. The log messages are downloaded and analyzed manually to create a test plan customized to the consumer that is fed back into the consumer system via an input file. Adjustments, such as changing of the manipulations, require stopping the current test, adjusting the test and starting a new test. Accordingly, tests can sometimes take days or weeks to set up. Known systems do not permit real-time modifications and dynamic manipulation of the test load.

### SUMMARY

The disclosed implementations allow for real-time modifications and dynamic manipulation of replayed web traffic by leveraging an independent manipulated function tied to a publish and subscription queue. The test implementor can substitute the function in/out while sending traffic through any number of instances of a test environment. The phrase “test environment”, as used herein refers to any secondary environment and is not limited to environments set up specifically for testing. For example, a production system could indeed test itself or even a new extension of itself before being activated for 100% any use-cases. Thus the test environment can be the same as, or overlap with, a production environment.

One aspect of the present disclosure relates to a system configured for testing a computing platform based on a replay of network traffic. The system may include one or more hardware processors configured by machine-readable instructions. The processor(s) may be configured to access a network activity log storing messages indicating previous network activity on a set of networked computing devices. The processor(s) may be configured to modify a set of messages and publish a set of modified messages to a subscription queue for use in a test environment. The publishing may include selectively reading the messages from the network activity log based on test parameters. The test parameters may include parameters indicating which of the messages to use for testing network traffic capability. The modifying may include modifying at least some of the messages to adapt the messages to a test environment that does not include the computing devices. The modifying may include creating a set of objects based on the modified messages. The processor(s) may be configured to send the modified objects as simulated network traffic to a replay test environment. The processor(s) may be configured to monitor the operation of the test environment based on the simulated network traffic.

Another aspect of the present disclosure relates to a method for testing a computing platform based on a replay of network traffic. The method may include accessing a network activity log storing messages indicating previous network activity on a set of networked computing devices. The method may include modifying a set of messages and publishing a set of modified messages to a subscription queue for use in a test environment. The publishing may include reading the messages from the network activity log based on test parameters. The test parameters may include parameters indicating which of the messages to use for testing network traffic capability. The modifying may include modifying at least some of the messages to adapt the messages to a test environment that does not include the computing devices. The modifying may include creating a set of objects based on the modified objects. The method may include sending the modified objects as simulated network traffic to a replay test environment. The method may include monitoring the operation of the test environment based on the simulated network traffic.

Yet another aspect of the present disclosure relates to a non-transient computer-readable storage medium having instructions embodied thereon, the instructions being executable by one or more processors to perform a method for testing a computing platform based on a replay of network traffic. The method may include accessing a network activity log storing messages indicating previous network activity on a set of networked computing devices. The method may include modifying a set of messages and publishing a set of modified messages to a subscription queue for use in a test environment. The publishing may include reading the messages from the network activity log based on test parameters. The test parameters may include parameters indicating which of the messages to use for testing network traffic capability. The modifying may include modifying at least some of the messages to adapt the messages to a test environment that does not include the computing devices. The modifying may include creating a set of objects based on the modified objects. The method may include sending the modified objects as simulated network traffic to a replay test environment. The method may include monitoring the operation of the test environment based on the simulated network traffic.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for testing network traffic capability based on a replay of network traffic, in accordance with one or more implementations.

FIG. 2 illustrates a method for testing network traffic capability based on a replay of network traffic, in accordance with one or more implementations.

FIG. 3 illustrates a method 300 for testing network traffic capability based on a replay of network traffic, in accordance with one or more implementations.

### DETAILED DESCRIPTION

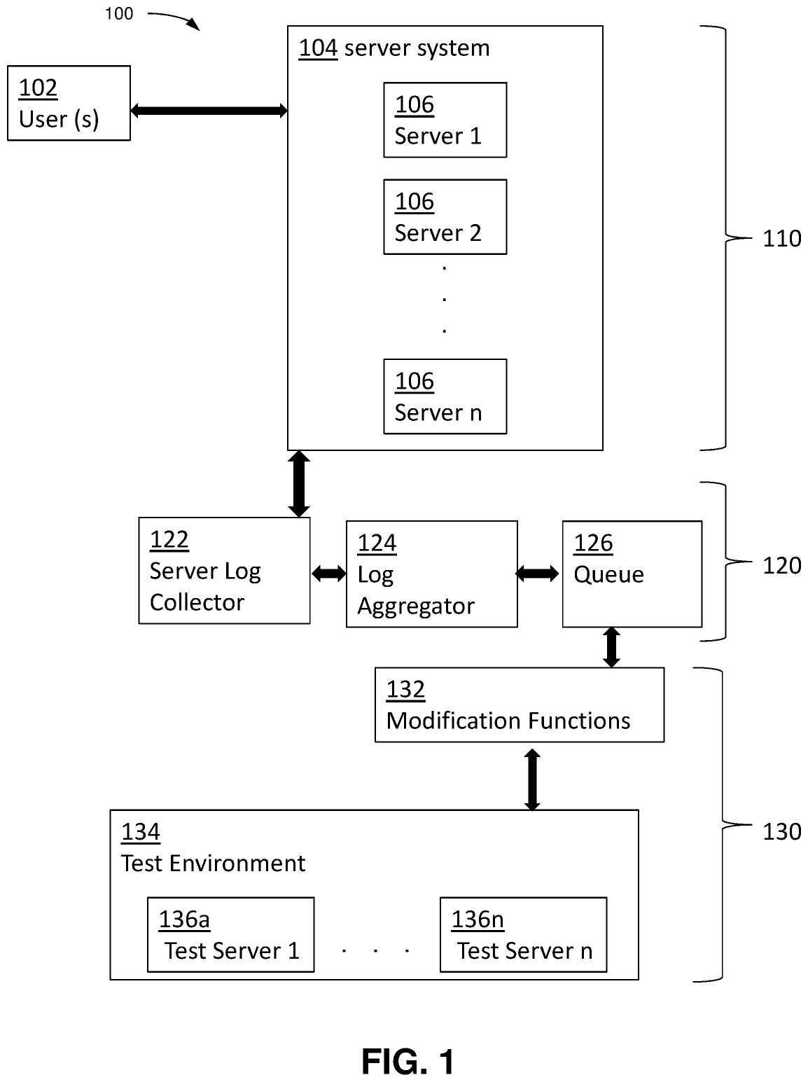

FIG. 1 illustrates an architecture 100 showing the relationship between networked system 110, proxy system 120, and test platform 130. Networked system 110 can be any type of computing environment having one or more computing devices. In this implementation, networked system 110 is a client server environment with one or more user device(s) 102, as client(s), communicating with server system 104 which includes one or more server(s) 106 (server 1, server 2, . . . server n). Networked system 110 can be a web-based system in which users receive a service from a service provider, such as social networking, content streaming, or other information services. The user device 102 communicates with server system 104 by exchanging messages, such as request messages, with servers 106. As a simple example, user device 102 can send a request for content to one or more of servers 106 and the content can be returned to the user in response to the request. The requests can be HTTP requests, for example.

Proxy system 120 includes server log collector 122, which collects a record of the messages exchanged by user device 102 and servers 106 of networked system 110, as well as other data, such as metadata. For example, a request will come into a server from an end user visiting a web site. Once the request arrives it will be logged in a general format by the server and written out and stored in a local and/or remote log file. In systems where the log cannot be sent to a remote relay/storage system directly and is instead logged locally to each server, a secondary process, such as fluentd or rsyslog, can be implemented to read the log files in real time and send log date to a remote system, such as server log collector 122 in this implementation.

Log aggregator 124, reads the various server logs and aggregates them into a single log that can be used to generate a test scenario. As the logs from multiple servers are being aggregated by the remote log aggregator 124, the files are monitored, and the aggregated files are sent to queue 126 and stored therein where they can be used by other systems, such as modification functions 132 discussed below. Queue 126 allows for other systems to be attached and process messages in parallel from the queue system via various consumer platforms. This can be implemented via any standard publish/subscribe system. In more modern systems this can be a consumer system such as a cloud function. From within the consumer system the requests can be modified, e.g. manipulated, enhanced, dropped, delayed, and the like, via code. This allows a robust system to be built to adapt to any business use-case necessary. As the logs from multiple sources are being aggregated via the remote system the secondary system can be implemented to watch those aggregate files or system and send them to a queuing system for consumption by other systems via subscriptions.

Test Platform 130 includes modification functions 132. Modification functions 132 can be configured as a serverless architecture, i.e. a software-based system where applications can be hosted by a third-party service. Modification functions 132 modify messages that are stored in queue 126 to implement and on-the-fly customized set of test objects that can be consumed by test environment 134.

The messages in queue 126 can be reproduced as objects to simulate live traffic in near real time. Test objects, resulting from modification services, are sent to test environment 134 for real-time testing by test servers 136a to 136n. Examples of modification are dynamic error introduction, standard replication of traffic, custom timeboxing of a major event from previous years as a way to prepare for upcoming live events, and test traffic amplification. Of course, test environment 134 can be monitored in real time to obtain results of the testing. Monitoring can be accomplished within test environment 134 or be a separate system.

Further errors can be introduced into messages, through the modification, to simulate failures. A custom timebox can be used to replicate network traffic to test against expected larger traffic events. Machine Learning and Artificial intelligence can be applied by Modification Function's 132 to intelligently detect patterns and modify outgoing requests to simulate expected future traffic patterns. Common request patterns can be detected and simulated in the objects to replay for optimizing caching mechanisms across a tier of servers that do not share a commonly shared cache. Replay of traffic can be supplemented with additional external data that is integrated into the manipulation function to simulate post data that end users would create for web forms or CRUD system testing. Security testing can be accomplished via modification of URLs or how requests are submitted to the external system based on pre-defined or self-learning systems integrated with the test environment. Further, multiple modification services can be applied in serial and/or parallel combination.

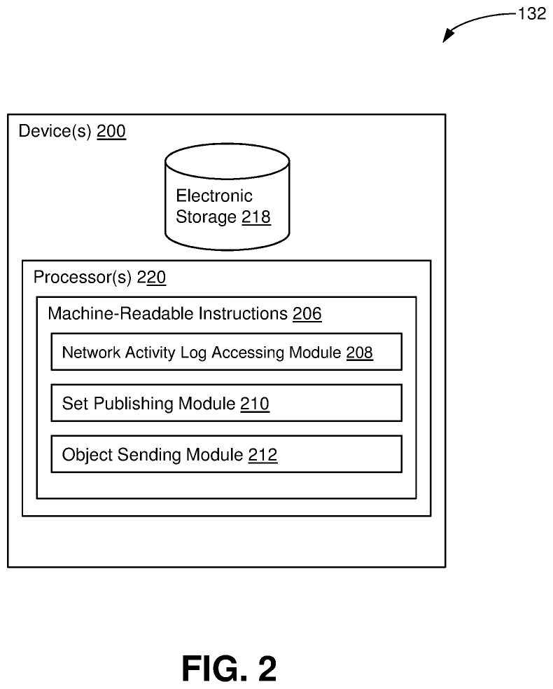

FIG. 2 illustrates the functional modules of modification functions 132, in accordance with one or more implementations. Modification functions 132 may include one or more computing devices 200. Devices 200 may be configured to communicate with one or more computing platforms according to a client/server architecture and/or other architectures, such as a peer-to-peer architecture. Device(s) 200 may be configured by machine-readable instructions that include one or more instruction modules. Each device 200 may include processor(s) 220 for executing instruction modules and electronic storage 218 for storing software associated with the instruction modules. The instruction modules may include computer program modules. The instruction modules may include one or more of network activity log accessing module 208, set publishing module 210, object sending module 212, and/or other instruction modules.

Network activity log accessing module 208 may be configured to access a network activity log storing messages indicating previous network activity on a set of networked computing devices, such a log stored in queue 126 of FIG. 1. Modifying module 210 may be configured to modify the messages and publish a set of modified messages to a subscription queue for use in a test environment. The modifying can be accomplished in accordance with test parameters. The test parameters may include parameters indicating which of the messages to use for testing network traffic capability. As noted above, the modifying may include modifying a url in the messages, modifying information in a user agent string of the messages, and/or introducing errors into the messages. The modifying may also include putting the messages into one or more timeboxes and/or. integrating additional external data into the messages to simulate end user post data. In some implementations, the modifying may include modifying at least some of the messages to adapt the messages to a test environment that does not include the computing devices. In some implementations, the modifying may include creating a set of objects based on the modified objects. In some implementations, the modifying step may include detecting common message patterns and the creating may include reconstructing the common message patterns. Object sending module 212 may be configured to send the modified objects as simulated network traffic to a replay test platform, such as test environment 134 of FIG. 1.

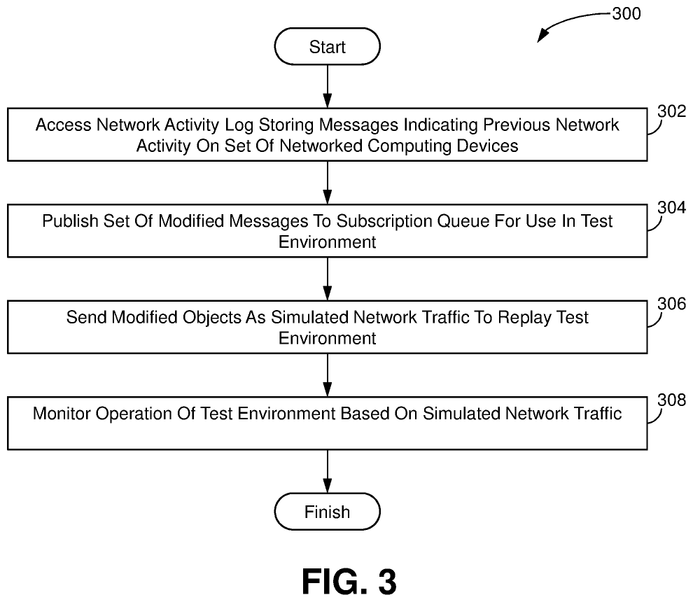

FIG. 3 illustrates a method 300 for testing network traffic capability based on a replay of network traffic, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include accessing a network activity log storing messages indicating previous network activity on a set of networked computing devices. Operation 302 may be performed by one or more hardware processors configured by machine-readable instructions including a module that is the same as or similar to network activity log accessing module 208, in accordance with one or more implementations.

An operation 304 may include modifying a set of modified messages to be sent to a subscription queue for use in a test environment. Operation 304 may be performed by one or more hardware processors configured by machine-readable instructions including a module that is the same as or similar to set publishing module 210, in accordance with one or more implementations.

An operation 306 may include sending the modified objects as simulated network traffic to a replay test environment. Operation 306 may be performed by one or more hardware processors configured by machine-readable instructions including a module that is the same as or similar to object sending module 212, in accordance with one or more implementations.

An operation 308 may include monitoring the operation of the test environment based on the simulated network traffic. Operation 308 may be performed by one or more hardware processors configured by machine-readable instructions including a module that is the same as or similar to operation monitoring module 214, in accordance with one or more implementations.

In some implementations, the various computing devices may be operatively linked via one or more electronic communication links. For example, such electronic communication links may be established, at least in part, via a network such as the Internet and/or other networks. A given computing device may include one or more processors configured to execute computer program modules. The computer program modules may be configured to enable user to interface with the system By way of non-limiting example, the given client computing platform 104 may include one or more of a server, a desktop computer, a laptop computer, a handheld computer, a tablet computing platform, a NetBook, a Smartphone, a gaming console, and/or other computing platforms.

The computing devices may include electronic storage, one or more processors, and/or other components, such as communication lines, or ports to enable the exchange of information with a network and/or other computing devices. The computing devices may include a plurality of hardware, software, and/or firmware components operating together to provide the functionality attributed herein to server(s) and other devices. For example, server(s) may be implemented by a cloud of computing platforms operating together as server(s).

Electronic storage may comprise non-transitory storage media that electronically stores information. The electronic storage media of the electronic storage may include one or both of system storage that is provided integrally (i.e., substantially non-removable) and/or removable storage that is removably connectable to devices via, for example, a port (e.g., a USB port, a firewire port, etc.) or a drive (e.g., a disk drive, etc.). Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage may include one or more virtual storage resources (e.g., cloud storage, a virtual private network, and/or other virtual storage resources). Electronic storage may store software algorithms, information determined by processor(s), information received from server(s), and/or other information that enables server(s) to function as described herein.

Processor(s) may be configured to provide information processing capabilities in server(s). As such, processor(s) may include one or more of a digital processor, an analog processor, a digital circuit designed to process information, an analog circuit designed to process information, a state machine, and/or other mechanisms for electronically processing information. In some implementations, processor(s) 120 may include a plurality of processing units. These processing units may be physically located within the same device, or include processing functionality of a plurality of devices operating in coordination. Processor(s) may be configured to execute modules by software; hardware; firmware; some combination of software, hardware, and/or firmware; and/or other mechanisms for configuring processing capabilities on processor(s). As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules are illustrated in FIG. 2 as being implemented within a single processing unit, in implementations in which processor(s) 220 includes multiple processing units, one or more of modules may be implemented remotely from the other modules. The description of the functionality provided by the different modules described herein is for illustrative purposes, and is not intended to be limiting, as any of modules may provide more or less functionality than is described. For example, one or more of modules may be eliminated, and some or all of its functionality may be provided by other modules.

The code sample below is an example of code implementing a cloud function to modify a request message for publication.

```
const https = require(‘https’);
const url = require(‘url’);
const agent = new https.Agent({keepAlive: true});
/* Set up default variables for site and user agents
  Flags for disabling and enabling logging and what percentage to replay
*/
const domain = “domain.com”;
const defaultUserAgent = “Mozilla/5.0 (Macintosh; Intel Mac OS X 10_12_5)
AppleWebKit/537.36 (KHTML, like Gecko) Chrome/66.0.3359.139 Safari/537.36”
const percent = “25”;
const justLoggin = true;
const consoleLog = true;
exports.cacheReplaySub = (event, callback) => {
  const pub subMessage = event, data;
  const pubSubMsg = pubsubMessage.data ? Buffer.from(pubsubMessage.data,
‘base64’).toString( ) : JSON.stringify(testPubMsg);
  /* Check if request should be fired off by cacluating a percentage of which
```

requests should be executed.
*/

if (fireReq( )) {

try {

var parsedSubMsg = parseReqMsg(JSON.parse(pubSubMsg));

} catch (e) {

if(consoleLog) {

console.error(e instanceof SyntaxError);
console.error(e.message);
console.error(e.stack);
console.error(e);

```
  }
  callback( );
```

}

/* Parse the URL and User agent coming in for manipulation if desired. */

```
  var reqUrl = parsedSubMsg[“reqUrl”];
  var reqUserAgent = parsedSubMsg[“reqUserAgent”];
  /* Add custom options to request based on manipulation factors. */
  var options = {
```

```
  host: domain,
  path: reqUrl,
  agent: agent,
  headers: {
```

“special-header”:“special value”,

“accept-encoding”:“gzip”,

“user-agent”:reqUserAgent

}

```
  }
  /* Capture logs for debugging */
  if(consoleLog) {
```

console.log(“https options:”, options)

}

/* Capture logs for debugging */
if(consoleLog) {
console.log(‘skipped entry, user-agent’);
}

callback( );

return;

/* If the request really needs to be executed fire it off if flag isn't

set.
*/

if (!justLoggin) {

https.get(options, (res) => {

/* console log for debugging if needed after request is fired off */

```
if(consoleLog) {
  console.log(‘statusCode:’, res.statusCode);
  console.log(‘headers:’, res.headers);
  console.log(‘URL completed:’, reqUrl);
}
```

/* return on successful replay call */

callback( );

}).on(‘error’, (e) => {

/* if an error occurred and we should log it do so */

```
if(consoleLog) {
  console.log(‘Errorwith, ${reqUrl}’);
  console, error(e);
}
```

/* return to calling function even if error occurs to finish

cleanly

*/

callback( );

});

} else {

/* log if enabled and request isn't a get request

if(consoleLog) {
console.log(‘no https.get just Loggin:’, reqUrl);
}

/* return to caller to cleanly finish request. */

callback( );

} else {

/* skip if percentage calculation isn't within scope */

if(consoleLog) {
console.log(‘skipped entry’);
}

/* return to caller to cleanly finish request. */

callback( );

};
/* Function to parse the request message to generate an object that is easier to work with
and manipulate in the above function.
*/
function parseReqMsg (message) {
if(consoleLog) {

console.log(“OG pubSub msg:”, message);

```
  }
  /* grab the url path out of the pub/sub payload message for storage and manipulation */
  var msgAdr = url.parse(message.jsonPayload.message.split(“ ”)[6], false);
  /* parse out the relative URL of the requst for usage in replaying the traffic to another
server host.*/
  var msgUrl = (msgAdr.pathname ? msgAdr.pathname : ‘/’) + (msgAdr.search ?
msgAdr.search : ‘’);
  /* parse out the User agent for manipulation to replay against another server host */
  var msgUserAgent = message.jsonPayload.message.split(“”)[7] ?
message.jsonPayload.message.split(“”)[7] : defaultUserAgent;
  /* Build a formal object to return to caller for manipulation and usage to build and
execute a request to secondary server */
  var reqInfoObj = {
```

```
  reqUrl:msgUrl,
  reqUserAgent:msgUserAgent
```

```
  };
  /* Log out for debugging if needed to see request object info */
  if(consoleLog) {
```

console.log(“reqInfoObj:”, reqInfoObj);

```
  }
  return reqInfoObj;
}
/* Simple function to run a random math to return a number from 1 to 100 to be used to
identify if we want to fire the request off to the secondary server or not
*/
function fireReq ( ) {
  var random = Math.floor((Math.random( ) * 100) + 1);
  /* If logging enabled spit out the percentage we should be replaying */
  if(consoleLog) {
```

console.log(‘Percentage used:’,percent);

```
  }
  if (random <= percent) {
```

command = true;

} else {

command = false;

```
  }
  /* returns true or false to be used if a request should be executed or not. */
  return command;
```

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for testing a computing platform based on a replay of network traffic, the system comprising:
one or more hardware processors configured by machine-readable instructions to:
access a network activity log storing messages indicating previous network activity on a set of networked computing devices; and
publish a set of modified messages to a subscription queue for use in a test environment;
wherein the publishing includes reading the messages from the network activity log based on test parameters, wherein the test parameters include parameters indicating which of the messages to use for testing network traffic capability, wherein the publishing includes modifying at least some of the messages to adapt the messages to a test environment that does not include the computing devices, wherein the publishing includes creating a set of objects based on the modified objects;
send the modified objects as simulated network traffic to a replay test environment; and
monitor the operation of the test environment based on the simulated network traffic.

2. The system of claim 1, wherein the modifying step comprises modifying a url in the messages.

3. The system of claim 1, wherein the modifying step comprises modifying information in a user agent string of the messages.

4. The system of claim 1, wherein the modifying step comprises introducing errors into the messages.

5. The system of claim 1, wherein the modifying step comprises putting the messages into one or more timeboxes.

6. The system of claim 1, wherein the modifying step comprises detecting common message patterns and the creating step comprises reconstructing the common message patterns.

7. The system of claim 1, wherein the modifying step comprises integrating additional external data into the messages to simulate end user post data.

8. A method for testing a computing platform based on a replay of network traffic, the method comprising:
accessing a network activity log storing messages indicating previous network activity on a set of networked computing devices;
publishing a set of modified messages to a subscription queue for use in a test environment;
wherein the publishing includes reading the messages from the network activity log based on test parameters, wherein the test parameters include parameters indicating which of the messages to use for testing network traffic capability, wherein the publishing includes modifying at least some of the messages to adapt the messages to a test environment that does not include the computing devices, wherein the publishing includes creating a set of objects based on the modified objects;
sending the modified objects as simulated network traffic to a replay test environment; and
monitoring the operation of the test environment based on the simulated network traffic.

9. The method of claim 8, wherein the modifying step comprises modifying a url in the messages.

10. The method of claim 8, wherein the modifying step comprises modifying information in a user agent string of the messages.

11. The method of claim 8, wherein the modifying step comprises introducing errors into the messages.

12. The method of claim 8, wherein the modifying step comprises putting the messages into one or more timeboxes.

13. The method of claim 8, wherein the modifying step comprises detecting common message patterns and the creating step comprises reconstructing the common message patterns.

14. The method of claim 8, wherein the modifying step comprises integrating additional external data into the messages to simulate end user post data.

15. A non-transient computer-readable storage medium having instructions embodied thereon, the instructions being executable by one or more processors to perform a method for testing a computing platform based on a replay of network traffic, the method comprising:
accessing a network activity log storing messages indicating previous network activity on a set of networked computing devices;
publishing a set of modified messages to a subscription queue for use in a test environment, wherein the publishing includes reading the messages from the network activity log based on test parameters, wherein the test parameters include parameters indicating which of the messages to use for testing network traffic capability, wherein the publishing includes modifying at least some of the messages to adapt the messages to a test environment that does not include the computing devices;
wherein the publishing includes creating a set of objects based on the modified objects;
sending the modified objects as simulated network traffic to a replay test environment; and
monitoring the operation of the test environment based on the simulated network traffic.

16. The computer-readable storage medium of claim 15, wherein the modifying step comprises modifying a url in the messages.

17. The computer-readable storage medium of claim 15, wherein the modifying step comprises modifying information in a user agent string of the messages.

18. The computer-readable storage medium of claim 15, wherein the modifying step comprises introducing errors into the messages.

19. The computer-readable storage medium of claim 15, wherein the modifying step comprises putting the messages into one or more timeboxes.

20. The computer-readable storage medium of claim 15, wherein the modifying step comprises detecting common message patterns and the creating step comprises reconstructing the common message patterns.
